(19) United States
(12) Patent Application Publication
(10) Pub. No.: US 2022/0355565 A1
(43) Pub. Date: Nov. 10, 2022

(54) PACKAGING SHEETING AND A METHOD OF MANUFACTURING PACKAGING SHEETING

(71) Applicant: UNIQCO-IP PTY LTD, Darling Point (AU)

(72) Inventors: Brandon PENN, Darling Point (AU); Mark DELAFOSSE, Carrara (AU); Wencong HUANG, Zhejiang (CN); Shi TIANYI, Zhejiang (CN)

(21) Appl. No.: 17/869,332

(22) Filed: Jul. 20, 2022

Related U.S. Application Data
(63) Continuation of application No. PCT/AU2021/050075, filed on Feb. 1, 2021.

(30) Foreign Application Priority Data
Jan. 30, 2020 (AU) 2020900243

(51) Int. Cl. B32B 3/12; B29C 51/10; B29C 48/08; B32B 27/08; B32B 27/20; B32B 27/32; B32B 37/24; B32B 37/00; B32B 7/05; B32B 37/14; C08J 5/18; C08K 3/26; C08K 3/34

(52) U.S. Cl. CPC B32B 3/12; B29C 51/10; B29C 48/08; B32B 27/08; B32B 27/20; B32B 27/32; B32B 37/24; B32B 37/0076; B32B 7/05; B32B 37/146; C08J 5/18; C08K 3/26; C08K 3/34; B29K 2023/065

(57) ABSTRACT

A method of manufacturing sheeting is provided, the method including the steps of forming multiple recesses in a symmetrical repeat pattern on a sheet of material, extruding a molten material to form an upper outside wall and a lower outside wall, interposing the formed sheet between the upper outside wall and the lower outside wall, and fixing the interposed sheet to the upper outside wall and the lower outside wall. Also provided is sheeting having an upper outside wall and a lower outside wall and an interposed sheet fixed between the outside walls. The interposed sheet includes multiple recesses in a symmetrical repeat pattern, where the upper and lower outside walls are, or the interposed sheet is, manufactured from a material which includes a polymeric material.

### CROSS REFERENCE TO RELATED APPLICATIONS

This application is a continuation of International Application No. PCT/AU2021/050075, filed Feb. 1, 2021, which claims priority to Australian Patent Application No. 2020900243, filed Jan. 30, 2020, the contents of each of which are incorporated by reference herein.

### FIELD OF THE INVENTION

The present invention relates to sheeting and a method of manufacturing sheeting, and in particular the invention relates to layered sheeting and a method of manufacturing layered sheeting.

The invention has been developed primarily as packaging sheeting and a method of manufacturing of packaging sheeting, and will be described in detail with reference to this application. However, it will be appreciated that the invention is not limited to this particular field of use.

### BACKGROUND

Layered sheeting encompasses a variety of different products, including corrugated cardboard, waxed cardboard, corrugated or fluted plastic sheeting, foam laminated papers, and corflute. Layered sheeting may provide desirable properties such as protective or cushioning effects, strength, load capacity, insulation, temperature control, or durability, and as a result may be preferred to non-layered sheeting or alternative competing products.

Layered sheeting may be manufactured in a wide range of configurations, and include creasing, folds, corners and inter-engaging sections, to suit the application.

Layered sheeting may be used in a variety of different contexts, for example, in boxes, pallets or other packaging, or signage and surface protection applications.

It may also be used in less conventional ways, for example to help stabilise layers on a pallet, be packed inside a box to divide products, or creased to suit dimensions of a product to provide wrap around protection of the product.

Layered sheeting used in the packaging industry is commonly used for packing, storing and shipping or transporting products, or for displaying products such as food or retail items. It may be preferred to packaging alternatives such as wooden pallets.

With particular reference to layered packaging sheeting, the design process may include many different considerations such as optimising the grade of sheeting, packaging design, flute direction and/or inner supports. The design of packaging also impacts its “load sharing” capacity, and its capacity to be stacked. Packaging used in long-term storage, and particularly in certain environments (e.g. where there is high humidity, or increased risk of insect infiltration), may also require extra strength, moisture or insect resistant properties.

Another key factor in the suitability of layered sheeting is its recyclability. Demand by consumers, manufacturers, and retailers alike for high recyclability of sheeting, and in particular sheeting used in packaging, is a growing concern. It is therefore an advantage that layered sheeting may be manufactured from a variety of different materials or composite materials, as the recyclability of those materials which comprise layered sheeting, and the recyclability of the layered sheeting product itself, must be carefully managed. By comparison, polystyrene, which provides good thermal solutions and insulation properties, is very difficult and unlikely to be recycled so the vast bulk of it ends up in landfill (over 250,000 cubic meters annually in Australia alone); waxed cardboard, which provides good moisture resistance, and strength, is also very difficult to recycle so also mostly ends up in landfill (over 400,000 tonnes per year in Australia alone).

A further consideration, particularly relevant to the manufacturing process, is that in the conventional layered (fluted) sheeting manufacturing process, the width of the machine is the maximum width that the sheeting may be. Conventionally, these machines have a width of 1.8 or 1.9 metres. This is a critical dimension as it dictates the maximum dimension the flute can run, and the overall size of the manufactured sheeting.

Another key consideration in layered sheeting, and the alternatives that compete against it, is the amount of material that is used in the overall sheeting configuration. Since all materials come at a cost, there can be substantial efficiencies in minimising the amount of materials used in the manufacturing of layered sheeting, particularly where the sheeting is made in large volumes.

The present invention seeks to provide a layered sheeting and method of manufacturing layered sheeting, which will overcome or substantially ameliorate at least some of the deficiencies of the prior art, or to at least provide a useful alternative thereto.

It is to be understood that, if any prior art information is referred to herein, such reference does not constitute an admission that the information forms part of the common general knowledge in the art, in Australia or any other country.

### SUMMARY

The present invention arises from a recognition that improvements in relation to manufacturing process and cost, or the recyclability, strength, range of use and/or water and leakproof resistance of layered sheeting is provided by a layered sheeting, or a method of manufacturing layered sheeting, set out herein.

In one aspect, there is provided layered sheeting, the sheeting comprising: an upper outside wall and a lower outside wall; and
an interposed sheet between the outside walls, the interposed sheet including multiple recesses in a symmetrical repeat pattern.

The recesses may be polygon-shaped. Alternatively, the recesses may be circular.

The layered sheeting may be packaging sheeting.

The recesses may be separated on an upper side by interconnected channels.

The upper outside wall, lower outside wall and interposed sheet may be of a

plastic material. The plastic may be any plastic or combination of plastics and/or plastics with additives, including: polyethylene and calcium carbonate; polypropylene; polypropylene and calcium carbonate; polypropylene and magnesium silicate; polypropylene and Talcum Powder.

The outer wall material and/or interposed sheet material may be wholly or substantially recyclable.

The recesses may be tessellated. The recesses may be hexagon-shaped.

The recesses may be filled or partially filled with a further material by any means, including cascade filing, waterfall filling, injection filling or the like.

The channels may be filled or partially filled with a further material by any

means, including cascade filing, waterfall filling, injection filling or the like. The channels may also be partitioned or sealed by an intervening post member on the upper side of the interposed sheet between adjacent recesses.

Edges of the sheeting may be crimped or sealed to prevent ingress to the channels or recesses.

The interposed sheet may be arranged in at least one layer, or at least two layers.

In a further aspect, there is provided a method of manufacturing layered sheeting, the method including:
thermoforming multiple recesses in a symmetrical repeat pattern on a sheet of material; extruding a molten material to form an upper outside wall and a lower outside wall;
interposing the thermoformed sheet between the upper outside wall and the
   lower outside wall; and
fixing the interposed sheet to the upper outside wall and the lower outside wall.

The recesses may be polygon-shaped. Alternatively, the recesses may be circular.

The layered sheeting may be packaging sheeting.

The thermoforming of multiple polygon-shaped recesses may also form interconnected channels between the recesses on an upper side of the interposed sheet.

The interposed sheet may be fixed to the upper and lower outside walls by lamination.

The method may include filling or partially filling the recesses with a further

material by any means, including cascade filling, waterfall filling, injection filling or the like. The filling or partial filling of the recesses may be effected before, or during fixing of the upper and lower outside walls to the interposed sheet.

The method may further include filling or partially filling the channels on the

upper side of the interposed sheet.

The method may also include insertion or inclusion of a post member between adjacent recesses, the post member being configured to partition, bridge or separate the channels.

The method may include sealing the edges of the sheeting. The sealing may be by crimping, laminating, gluing, or any other practicable means.

The method of this disclosure may include at least a second interposed sheet fixed between a first interposed sheet and the upper or lower outside wall. The, or each interposed sheet may also be fixed to an intermediate wall between the interposed sheets.

The upper outside wall, lower outside wall and interposed sheet may be of a

plastic material. The plastic may be any plastic or combination of plastics and/or plastics with additives, including polyethylene and calcium carbonate; polypropylene; polypropylene and calcium carbonate; polypropylene and magnesium silicate; polypropylene and Talcum Powder and/or carboxymethyl cellulose (CMC).

The outer wall material and/or interposed sheet material may be wholly or substantially recyclable.

In a further aspect, there is provided layered sheeting, the layered sheeting comprising:
an upper outside wall and a lower outside wall; and
an interposed sheet fixed between the outside walls, the interposed sheet including multiple recesses in a symmetrical repeat pattern;
wherein the upper and lower outside walls are, or the interposed sheet is, manufactured from a material which includes a polymeric material.

The recesses may be polygon-shaped. The recesses may be hexagonal.

Alternatively, the recesses may be circular.

The sheeting may be packaging sheeting.

Preferably, the upper and lower outside walls and the interposed sheet are both manufactured from a material which includes polymeric material.

The polymeric material may be wholly or substantially recyclable.

The recesses may be formed by thermoforming or vacuum forming the interposed sheet.

The polymeric material may be polyethylene (e.g. low-density polyethylene, medium-density polyethylene or high-density polyethylene, etc).

The material may be high-density polyethylene, and may include an additive comprising calcium carbonate.

The polymeric material may be polypropylene, or a be a composite material including polypropylene and a talcum powder additive.

The fixing of the interposed sheet to the upper outside wall and the lower outside wall may be by lamination, or by heat lamination.

The interposed sheet may include channels interconnected between the recesses. The interconnected channels may be on an upper side of the interposed sheet. The recesses and channels may be formed on the sheet in a tessellated pattern. The tessellated pattern on the interposed sheet may be surrounded by a flat or non-patterned portion of the sheet.

The recesses and/or channels may be partially or fully filled with a further material, the further material being filled by cascade filling.

At least one edge of the sheeting may be sealed. The at least one sealed edge of the sheeting may be sealed by crimping, heat crimping or heat compression.

A further interposed sheet may be positioned between the upper outside wall and a further upper outside wall.

At least a second interposed formed sheet may be fixed between a first interposed formed sheet and the upper or the lower outside wall. Each interposed sheet may be fixed to an intermediate wall between the interposed sheets.

In a further aspect, there is provided a method of manufacturing layered sheeting, the method comprising the steps of:
forming multiple recesses in a symmetrical repeat pattern on a sheet of material;
extruding a molten material to form an upper outside wall and a lower outside wall;
interposing the formed sheet between the upper outside wall and the lower outside wall; and
fixing the interposed sheet to the upper outside wall and the lower outside wall.

The recesses may be polygon-shaped. Alternatively, the recesses may be circular.

The method may comprise a method of manufacturing packaging sheeting.

The forming of the multiple recesses may be by thermoforming, or by vacuum forming.

The material comprising the formed sheet and/or the molten material may include a polymeric material. The material may be substantially, or entirely, a polymeric material. The polymeric material may be polyethylene, or high-density polyethylene or polypropylene.

The material may include one or more additives. The material may be substantially, or entirely, a polymeric material including one or more additives. The material may include a calcium carbonate additive, or a talcum powder additive. Other additives may be include, for example those that assist in the strength, or control electrical conductivity, or improve thermal resistance, of the material.

The material may be wholly or substantially recyclable.

The material may be a composite material comprising polyethylene and calcium carbonate. In another preferred form, the material is a composite material comprising high density polyethylene and calcium carbonate. In a further preferred form, the material is a composite material comprising polypropylene and talcum powder.

The fixing of the interposed sheet to the upper outside wall and the lower outside wall may be by lamination, or by heat lamination.

The fixing of the interposed sheet to the upper outside wall and the lower outside wall may comprise adding a glue or resin between the interposed sheet and the upper outside wall and the lower outside wall, then laminating the upper outside wall and the lower outside wall to the interposed sheet.

The interposed sheet may include interconnected channels between the recesses. The interconnected channels and recesses may be formed in a tessellated pattern on the interposed sheet.

The thermoforming or vacuum forming of multiple polygon-shaped recesses may form the interconnected channels between the recesses.

The method may include the step of filling or partially filling the recesses and/or channels with a further material.

The step of filling or partially filling the recesses and/or channels with the further material may be by cascade filling.

The filling or partial filling of the recesses and/or channels may be effected before, or during, fixing of the upper and lower outside walls to the interposed sheet.

The filling or partial filling of the recesses and/or channels may be effected on those recesses and/or channels of the interposed sheet.

The method may include the step of sealing the edges of the sheeting.

The sealing may be effected by crimping, heat crimping or heat compression.

A second interposed formed sheet may be fixed between a first interposed formed sheet and the upper or the lower outside wall.

The method may further comprise the steps of:
interposing a further formed sheet between the upper outside wall and a further upper outside wall; and
fixing the further formed sheet to the upper outside wall and the further upper outside wall.

Each interposed sheet may be fixed to an intermediate wall between the interposed sheets.

A plurality of upper and lower outside walls may be extruded, and formed separately from a plurality of formed sheets, and the plurality of walls and formed sheets may be subsequently fastened together in a lamination process.

A multilayer sheeting may be formed in accordance with the manufacturing method of this disclosure, the multilayer sheeting including at least two formed sheets, wherein at least two of the formed sheets include differing polygon shaped recesses.

The recesses of interposed sheets in a multilayer sheeting may not be aligned or line up with each other.

The features described in relation to one or more embodiments of the invention are to be understood as applicable to other embodiments of the invention.

### BRIEF DESCRIPTION OF THE DRAWINGS

Notwithstanding any other forms or methods which may fall within the scope of the present invention, preferred embodiments of the invention will now be described, by way of example only, with reference to the accompanying drawings in which:

FIG. 1 shows a top perspective view of packaging sheeting according to one embodiment of the invention.

FIG. 2 shows an exploded view of the sheeting of FIG. 1.

FIG. 3a shows a top view of in interposed layer of packaging sheeting according to one embodiment of the invention.

FIG. 3b shows a top perspective view of the layer of FIG. 3a.

FIG. 4 shows a sectional A-A side view of the sheeting of FIG. 1.

FIG. 5 shows a sectional view of a multi-layer packaging sheeting according to one embodiment of the invention.

FIGS. 6a and 6b show top views of interposed sheets for packaging sheeting according to further embodiments of the invention.

FIG. 7 shows a top perspective view of packaging sheeting according to a further embodiment of the invention.

FIG. 8 shows an exploded view of the sheeting of FIG. 7.

FIG. 9 is a flowchart depicting the steps involved in a method comprising an embodiment of the invention.

FIG. 10 is a flowchart depicting the steps involved in another method comprising an embodiment of the invention.

### DETAILED DESCRIPTION OF THE PREFERRED EMBODIMENTS

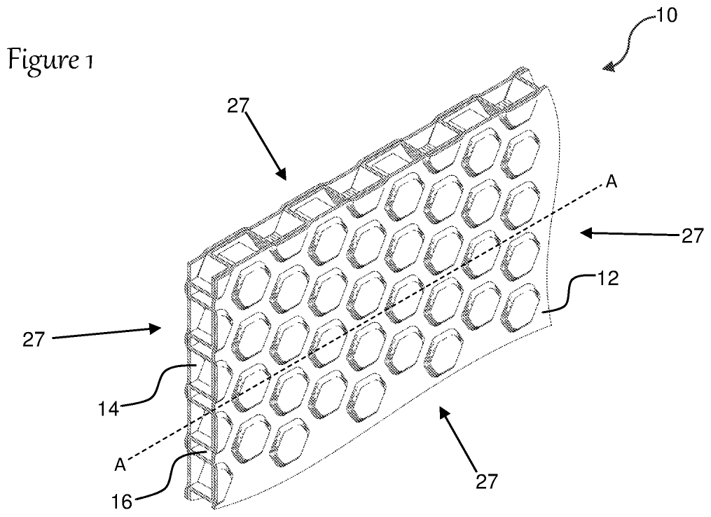

In FIG. 1, reference numeral 10 generally indicates a first embodiment of

packaging sheeting viewed from a top perspective, indicating the upper outside wall 12, the lower outside wall 14, and the interposed sheet 16.

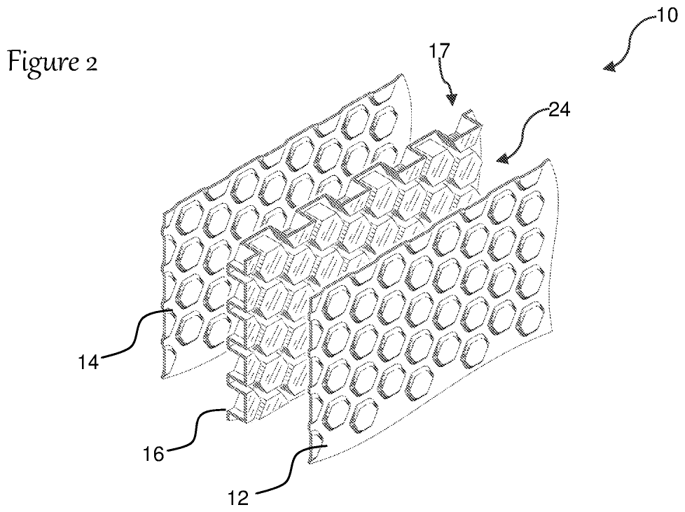

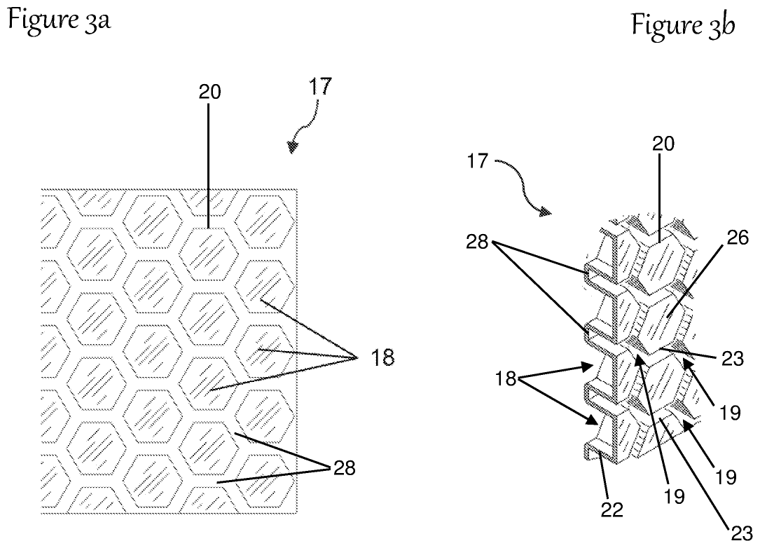

FIG. 2 is an exploded view of the sheeting 10. FIGS. 3a and 3b show in detail an underside 17 of the interposed sheet 16, absent the upper outside wall 12 and lower outside wall 14. The recesses, in this embodiment hexagon-shaped recesses 18, can be any practicable uniform size, for example each recess 18 can have an edge length 20 of from 1 mm to 10 mm, and a height 22 of from 0.5 mm to 6 mm. The distance between adjacent hexagon-shaped recess 18 can be from 0.5 mm to 6 mm.

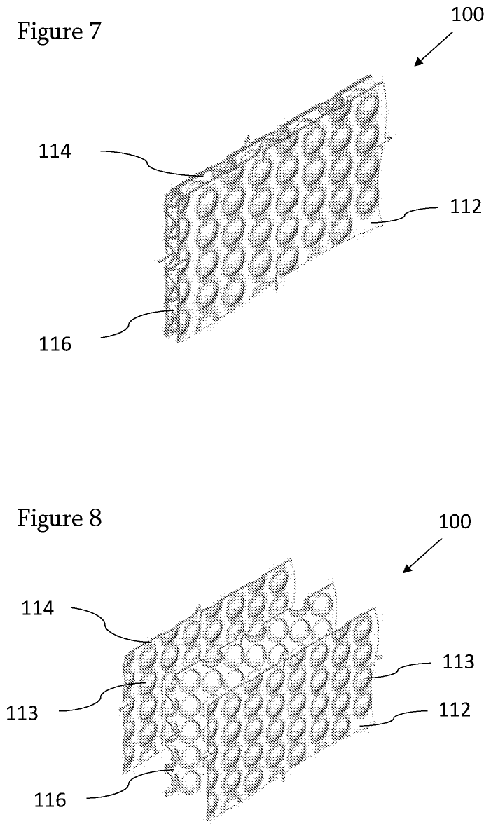

The hexagonal shape of the recesses is particularly preferred as it provides a consistent gap (or channel) between the recesses which results in a stronger overall structure. Other shapes are also within the scope of the invention. These may include irregular gaps (or channels) between the walls, where some gaps are larger in certain areas and narrower in other areas. A circular recess, see FIGS. 7 and 8, is also within the scope of the invention.

The interposed sheet 16 can be of any material, including plastic. The plastic

material can be any plastic or combination of plastics and/or plastics with additives, including: polyethylene and calcium carbonate; polypropylene; polypropylene and calcium carbonate; polypropylene and magnesium silicate; polypropylene and talcum powder and/or CMC.

The recesses of the interposed sheet 16 can be formed by any practicable method. When the material of the sheet 16 is plastic, the recesses can be formed by extrusion, vacuum forming and/or thermoforming.

In the embodiment of the packaging sheeting according to one embodiment of the invention shown in FIGS. 1, 2 and 3, the upper outside wall 12 can be fixed to an upper side 24 of the interposed sheet. The lower outside wall 14 can be fixed to the underside 17 of the sheet 16. Fixture can be by any practicable means, including lamination, gluing and the like.

The walls 12, 14 can be any thickness, including from about 100 μm to about 500 μm.

The upper outside wall 12 and lower outside wall 14 can be of any practicable material, including plastic. The plastic can be any plastic or combination of plastics and/or plastics with additives, including: polyethylene and calcium carbonate; polypropylene; polypropylene and calcium carbonate; polypropylene and magnesium silicate; polypropylene and talcum powder and/or CMC.

When the outside walls 12, 14 are of plastic material, the walls 12, 14 can be extruded from molten plastic, and subsequently fixed to the interposed layer 16 by, for example, lamination, gluing or welding.

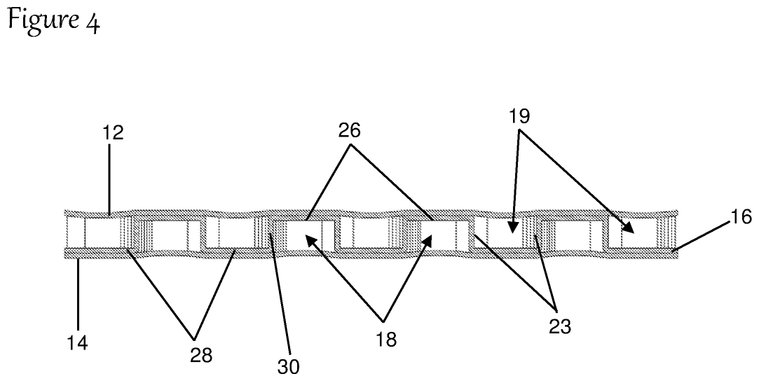

FIG. 4 is a representation of a side view of the section through A-A of FIG. 1. Referring to FIGS. 2, 3a and 3b and 4, the upper outside wall 12 can be fixed to the top hexagonal face 26 of each recess 18 of the interposed sheet 16. The lower outside wall 14 is fixed to the bottom ledge 28 of each interconnecting wall 30 of each recess 18. In this way, the interposed sheet 16 is ‘sandwiched’ between the upper wall 12 and the lower wall 14, to give packaging sheeting of from about 0.5 mm to about 8 mm thick.

Interconnected channels 19 are formed on the upper side 24 of the interposed sheet, between the recesses 18, and defined by the outer edges 23 of the interconnecting walls 30. The channels 19 can be filled or partially filled with material that can increase a desired property of the sheeting, for example strength, resilience, a reduced thermal conductivity, water resistance, pliability and the like.

The material can be any practicable material, and can be introduced into the channels 19 at any time before, during or after fixing of the interposed sheet 16 to the upper wall 12 and lower wall 14. The filled channels 19 are located on an upper side of the interposed sheet 16 during the process of filling, so that the filling material is more easily introduced from above the sheet and using the force of gravity to assist with such introduction. This may be contrasted with introducing the filling material from below where it would be introduced against the force of gravity, which would be the case if the filled channels 19 were located on a lower side of the interposed sheet 16.

The channels 19 can also be partitioned or attenuated by inclusion of one or more intervening post member (not shown) between the outer edges 23 of adjacent recesses 18.

The recesses 18 can be filled or partially filled with material that can increase a desired property of the sheeting, for example strength, resilience, a reduced thermal conductivity, water resistance, pliability and the like. The material can be any practicable material, and can be introduced into the recesses 18 at any time before, during or after fixing of the interposed sheet 16 to the upper wall 12 and lower wall 14.

The edges 27 of the packaging sheet can be sealed or partially sealed to prevent ingress of unwanted materials, for example water, dust, contaminants, microorganisms and the like. Sealing can be by any practicable method, such as crimping, gluing, clamping, and laminating,

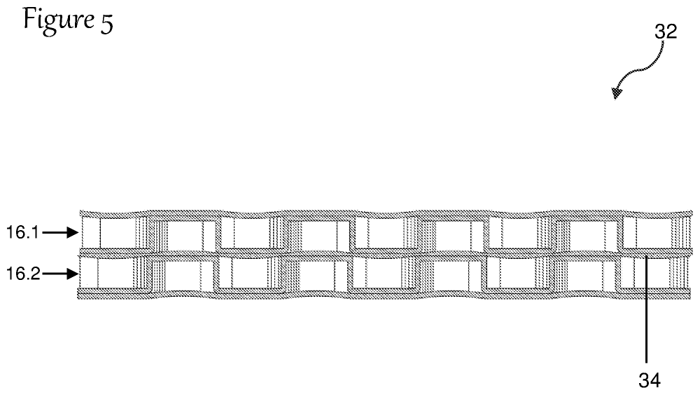

Referring to FIGS. 4 and 5, the interposed sheet 16 can be arranged in one layer (FIG. 4), or more than one layer (FIG. 5). When there is more than one layer, as in the packaging sheeting 32 which has two layers, an intermediate wall 34 can be included between the first interposed sheet 16.1 and the second interposed sheet 16.2. Further layers can be added to the packaging sheeting in a similar manner. This intermediate wall 34 between the interposed sheets 16.1 and 16.2 is there to provide a supporting layer in between aligned recesses and channels to increase the overall strength of the packaging sheeting 32. The intermediate wall 34 creates a further cross fluting and cross laminating benefit to increase the strength of the sheeting 32.

In this two-layer embodiment of the invention, the packaging sheeting 32 can have a thickness from about 1 mm to about 16 mm thick. However, other thicknesses are also possible. Furthermore, the sheets 16.1, 16.2 can have different thicknesses. It will be appreciated that these thicknesses can vary, if necessary. A three-layer example can have a thickness of about 24 mm.

A benefit of the two-layer aspect is the creation of a twin cushion effect of this material, which has increased strength. This is particularly beneficial in the context of the sheeting that is able to be made without the limitations of dimensions that apply to conventional fluted sheeting (as discussed elsewhere in this application). In particular, large sheet requirements may be met using the manufacturing process of the embodiments of the invention, including panels required for construction (e.g. housing) and other applications.

Multilayer embodiments of the layered sheeting according to embodiments of the invention can include multiple interposed sheets of differing polygon shaped recesses. For example, a first interposed sheet of hexagonal shaped recesses can be layered with a second interposed sheet of square shape recesses.

In alternative embodiments (not shown) the recesses of interposed sheets in a multilayer sheeting may not be aligned (i.e. line up) with each other, to provide the sheeting material a stronger crossed-flute effect.

The packaging sheeting according to embodiments of the invention can provide sheeting with strength of up to 30% greater (or more) than that provided by conventional packaging sheeting. This can be indicated by the take-up factors of the sheeting of the embodiments of the invention.

Take-up factor, or take-up ratio, is a measure of the amount of plastic material required for sheeting to provide a specified strength. Take-up factor is calculated by dividing the length of a fluted sheet by the length of plastic sheet required for the fluted member, for a given strength of sheeting. Alternatively stated, the sheeting of the embodiments of the invention require substantially less plastic material for the interposed sheet than fluted sheeting, to provide comparable strength. It follows that the greater the take-up factor, the more material has been used to manufacture the sheeting. Generally speaking, this would be expected to proportionately increase the strength of the sheeting. The sheeting according to the embodiments of the invention can show increased strength at lower take-up factors than conventional sheeting.

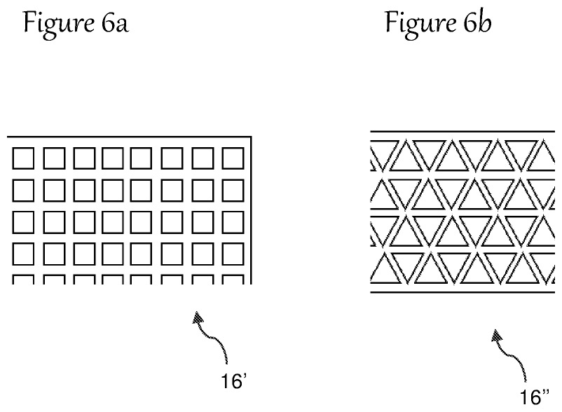

FIG. 6 shows interposed sheets 16′ and 16″ for packaging sheeting according to further embodiments of the invention. For example, in FIG. 6a, the polygon recesses of the interposed sheet 16′ are square, and in FIG. 6b the polygon recesses of the interposed sheet 16″ are triangular.

The orientation and configuration of the recesses of the interposed sheet 16 of packaging sheeting according to the embodiments of the invention imparts an enhanced resistance to crushing to the sheeting.

In the examples described above, the walls 12,14 and the interposed sheets 16 can be extruded separately and subsequently fastened together in a lamination process. Depending on the size requirements, any number and configuration of the sheets 16 of a predetermined width can be extruded separately from any number of the walls 12, 14 of a predetermined width.

A thickness of the material used for the walls 12, 14 is can be from about 100 μm to about 750 μm, depending on the application. A thickness of the material used for the interposed sheet 16 can be from about 100 μm to about 750 μm, depending on the application. Other thickness materials can be used in layered sheeting according to embodiments of the invention. The weight of the material used for the walls 12, 14 and interposed sheet 16 can be from about 100 gsm to about 1000 gsm.

Instead of being discreet, the interposed sheets 16 and the outside walls 12,14 can be in the form of a unitary, one-piece structure. Such a structure can be the result of an extrusion process, for example, or some other process capable of producing such a structure.

Furthermore, the layered sheeting can have three or more layers of the interposed sheet 16, depending on requirements.

The walls 12,14 and the interposed sheet 16 can be of a plastics material. The plastics material can be, or can include, polyethylene or polypropylene. The plastics material can be, or can include, recycled polyethylene and can include CMC.

The plastics material can be a composite material. The composite material can be polyethylene combined with calcium carbonate. Recycled polyethylene can also be included. The percentages of polyethylene, calcium carbonate, and recycled polyethylene can depend on the application of the sheeting.

The composite material can also be polypropylene or polyethylene combined with magnesium silicate, also known as talc, which is an ingredient of talcum powder.

This combination can also include recycled polyethylene, and can include CMC.

Broadly, the plastics material can be any plastics material capable of extrusion or other process to result in a sheet form, and the density of the material used can depend on the intended application.

The plastics material can include further additives such as, but not limited to, one or more of material related to anticounterfeiting, antimicrobials/bio-stabilisers, antioxidants, antistatic agents, biodegradable plasticisers, degradable plasticisers, blowing agents, external lubricants, fillers/extenders, flame retardant, fragrances, heat stabilisers, impact modifiers, internal lubricants, light stabilisers, pigments, plasticisers, process aids and reinforcements.

It will be appreciated that the various parameters described herein can be varied depending on the desired application for the sheeting. Thus, the sheeting embodiments are not limited to spacing, layer thickness, type of plastics material, weight (for example, in grams per square metre) of the plastics material, or method of production.

The sheeting can have multiple applications and is not limited to any single application. For example, the sheeting can be used for packaging and construction applications where the inherent resistance to moisture damage of the plastics material is useful. Such applications can also be those in which the inherent resistance to damage by insects of the plastics material is useful.

In FIG. 7, reference numeral 100 indicates a further embodiment of packaging sheeting viewed from a top perspective, indicating the upper outside wall 112, the lower outside wall 114, and the interposed sheet 116. The recesses in interposed sheet 116 are circular-shaped when viewed in plan (the recesses are hemispherical in three dimensions).

FIG. 8 is an exploded view of the sheeting 100.

Outside walls 112, 114, when fixed to the interposed layer 116, include indentations 113 that mirror the recesses 118. This provides, among other benefits, a more secure fixing between the walls 112, 114 and the interposed layer 116 as sliding movement of the walls 112, 114 relative to the interposed layer 116 is inhibited by the indentations 113. The indentations are formed in the outside walls 112, 114 by the fixing process during the manufacture of the sheeting 100.

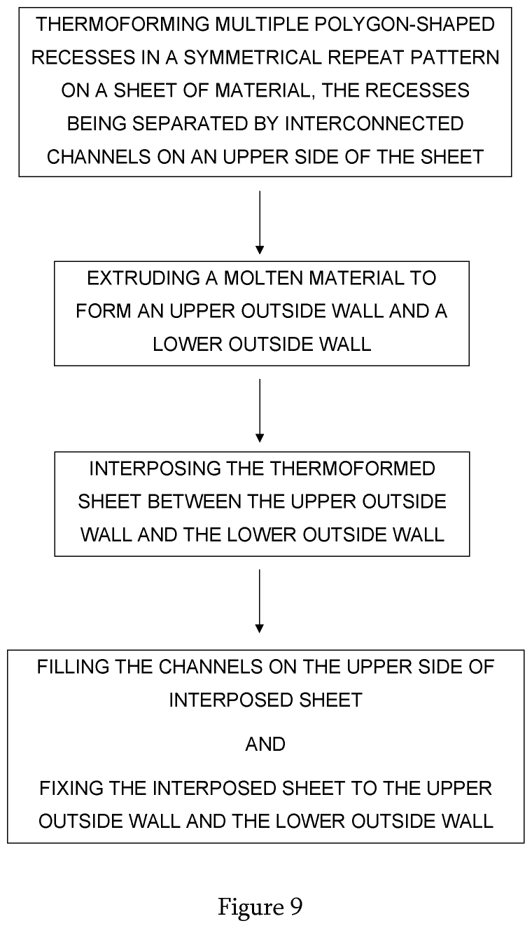

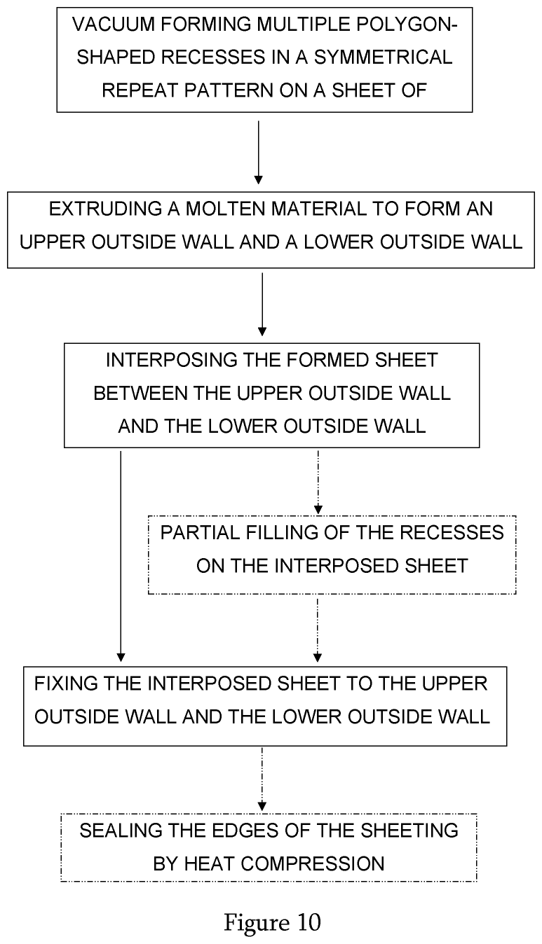

FIGS. 9 and 10 depict example manufacturing methods of layered sheeting for packaging.

In FIG. 9, there is presented a four-step method including:
1. Thermoforming multiple polygon-shaped recesses in a symmetrical repeat pattern on a sheet of material, the recesses being separated by interconnected channels on an upper side of the sheet;
2. Extruding a molten material to form an upper outside wall and a lower outside wall;
3. Interposing the thermoformed sheet between the upper outside wall and the lower outside wall; and
4. Filling the channels on the upper side of interposed sheet during the process of fixing the interposed sheet to the upper outside wall and the lower outside wall.

The method shown in FIG. 9 includes forming channels on an upper side of the sheet of material, and those channels are filled during the fixing of the interposed sheet to the upper and lower outside walls.

In FIG. 10, there is also presented a four-step manufacturing method including:
1. Forming multiple polygon-shaped recesses in a symmetrical repeat pattern on a sheet of material;
2. Extruding a molten material to form an upper outside wall and a lower outside wall;
3. Interposing the formed sheet between the upper outside wall and the lower outside wall; and
4. Fixing the interposed sheet to the upper outside wall and the lower outside wall.

The method shown in FIG. 10 can be contrasted to that shown in FIG. 9 in that the recess forming process is by vacuum-forming (in other methods of the invention, it may be thermoforming or another forming method known to the skilled addressee), and it includes two optional steps, namely: (i) partial filling of the recesses on the interposed sheet (prior to fixing of the interposed sheet to the upper and lower outside walls), and (ii) sealing of the edges of the sheeting (in this case, by heat compression).

Benefits provided by the embodiments of the invention are manifold, and include, depending on the embodiment of the invention, one or more of the following:
A recyclable layered sheeting alternative to waxed cardboard, polystyrene, or other sheeting or alternative competing products (e.g. wooden pallets and corner angles).
A layered sheeting that requires relatively less material to provide equivalent strength (i.e. sheeting that is strong yet has low take-up factors). This provides for cost savings due to less material usage.
A manufacturing process that permits, and a layered sheeting that provides, capacity for further material to fill in recesses to increase a desirable property of the sheeting, for example strength, resilience, low heat conduction, water resistance or pliability.
Multi-directional flute integrity where the strength of the layered sheeting does not depend on any particular orientation of the interposed sheet, unlike conventional fluting where the strength of the sheeting comes from the flute direction being vertical to the force applied (i.e. the normal corrugated board gains its strength by the flutes running vertically). So the width of the corrugator presents limits in the sheeting width. By contrast, the layered sheeting the subject of the invention is not limited to applications having a conventional 1.8 or 1.9 metre flute direction. Therefore, a number of products such as large corner angles (e.g. up to 2.6 m width), dump bins, large signage or protective surface sheeting, as well as very large format and heavy-duty bins, are able to be manufactured. In other words, the invention provides for a fluting shape (e.g. hexagonal) where there is no set x or y flute direction. As such, even though a manufacturing maximum width of 1.9 metres across the machine may apply, the flute direction is now irrelevant due to the symmetric repeat pattern of the recesses, and this permits much larger scale and format manufacturing.
Related to the above benefit, the ability to manufacture large dimension packaging sheeting (e.g. up to 10 meters width) on conventional machinery. The invention is not limited to the 1.8 or 1.9 meter-wide extruder dimension that defines the flute width).
A wide range of applications including pallets, corner angles, protective packaging, construction pods and signage.

### General/Interpretation

Throughout the specification, the use of common reference numerals is intended to indicate like parts or components across the drawings, unless otherwise indicated. However, such use of common reference numerals is for convenience only and is not intended to indicate that the like parts or components need to be identical. The inventor(s) envisages that, where feasible, various components described throughout the drawings can be interchanged to provide further embodiments that are not specifically described herein.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for description

and should not be regarded as limiting. The described embodiments are intended to be illustrative of the invention, without limiting the scope thereof. The invention is capable of being practiced with various modifications and additions as will readily occur to those skilled in the art.

When any number or range is described herein, unless clearly stated otherwise, that number or range is approximate. Recitation of ranges of values herein are intended to serve as a shorthand method of referring individually to each separate value falling within the range, unless otherwise indicated herein, and each separate value and each separate subrange defined by such separate values is incorporated into the specification as if it were individually recited herein.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

The claims following the Detailed Description are hereby expressly incorporated into this Detailed Description, with each claim standing on its own as a separate embodiment of this invention.

Where the preamble of a claim recites a purpose, benefit or possible use of the claimed invention, it does not limit the claimed invention to having only that purpose, benefit or possible use.

Words indicating direction or orientation, such as “front”, “rear”, “back”, etc, are used for convenience. The inventor(s) envisages that various embodiments can be used in a non-operative configuration, such as when presented for sale. Thus, such words are to be regarded as illustrative in nature, and not as restrictive.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

The mere disclosure of a product or method element in the specification should not be construed as being essential to the invention claimed herein, except where it is either expressly stated to be so or expressly recited in a claim.

The terms in the claims have the broadest scope of meaning they would have been given by a person of ordinary skill in the art as of the relevant date.

The terms “a” and “an” mean “one or more”, unless expressly specified otherwise.

Neither the title nor any abstract of the present application should be taken as limiting in any way the scope of the claimed invention.

What is claimed is:

1. A method of manufacturing sheeting, the method comprising the steps of:
forming multiple recesses and/or channels in a symmetrical repeat pattern on a sheet of material to form a formed sheet;
extruding a molten material to form an upper outside wall and a lower outside wall;
filling or partially filling the recesses and/or channels on the formed sheet with a further material;
interposing the formed sheet between the upper outside wall and the lower outside wall;
fixing the formed sheet to the upper outside wall and the lower outside wall;
wherein:
the step of filling or partially filling the recesses and/or channels is by cascade filling or waterfall filling on said recesses and/or channels; and
the further material provides improved strength, resilience, resistance and/or thermal properties of the sheeting.

2. The method of claim 1, in which the filling or partial filling of the recesses and/or channels on the formed sheet is effected before, or during, fixing of the upper and lower outside walls to the formed sheet.

3. The method of claim 1, in which the filling or partial filling of the recesses and/or channels on the formed sheet is effected from above the formed sheet on those recesses and/or channels on the formed sheet before fixing of the upper and lower outside walls to the formed sheet.

4. The method of claim 3, in which the further material provides reduced thermal conductivity of the sheeting.

5. Sheeting comprising:
an upper outside wall and a lower outside wall; and
a formed sheet interposed and fixed between the upper outside wall and the lower outside wall, the formed sheet including multiple recesses and/or channels in a symmetrical repeat pattern;
wherein:
the upper outside wall and the lower outside wall are, or the formed sheet is, manufactured from a material which includes a polymeric material;
the recesses and/or channels on the formed sheet are at least partially filled with a further material providing improved strength, resilience, resistance and/or thermal properties of the sheeting; and
the further material is filled by cascade filling or waterfall filling on the recesses and/or channels.

6. The sheeting of claim 5, in which the further material provides reduced thermal conductivity of the sheeting.

7. The sheeting of claim 5, in which the recesses and/or channels of the formed sheet are formed by thermoforming or vacuum-forming.

8. The sheeting of claim 5, in which the upper and lower outside walls, and the formed sheet, are all manufactured from the material which includes the polymeric material.

9. The sheeting of claim 5, in which the polymeric material is polyethylene.

10. The sheeting of claim 5, in which the material is a composite material including high density polyethylene and a calcium carbonate additive.

11. The sheeting of claim 5, in which the material is a composite material including polypropylene and a talcum powder additive.

12. The sheeting of claim 5, in which an upper side of the formed sheet includes channels interconnected between the recesses.

13. The sheeting of claim 5, in which at least one edge of the sheeting is sealed.

14. The sheeting of claim 13, in which the least one edge of the sheeting is sealed by heat crimping or heat compression.

15. The sheeting of claim 5, in which the recesses are hexagon-shaped.

16. The sheeting of claim 5, including at least a second formed sheet fixed between a first formed sheet and the upper outside wall or the lower outside wall.

17. The sheeting of claim 16, in which each of the first formed sheet and the second formed sheet is fixed to an intermediate wall between the first formed sheet and the second formed sheet.

18. The sheeting of claim 5, in which the recesses and channels are formed on the sheet in a tessellated pattern.

19. The sheeting of claim 18, in which the tessellated pattern on the formed sheet is surrounded by a flat or non-patterned portion of the sheet.

20. The sheeting of claim 5, in which the sheeting comprises packaging sheeting.
